(19) United States
(12) Patent Application Publication
(10) Pub. No.: US 2025/0058937 A1
(43) Pub. Date: Feb. 20, 2025

(54) Single Bag Dispensing Waste Bag Roll

(71) Applicant: Paul Vizzio, New York, NY (US)

(72) Inventor: Paul Vizzio, New York, NY (US)

(21) Appl. No.: 18/785,079

(22) Filed: Jul. 26, 2024

Related U.S. Application Data
(60) Provisional application No. 63/532,836, filed on Aug. 15, 2023.

(51) Int. Cl. B65D 33/00; B65F 1/00

(52) U.S. Cl. CPC B65D 33/002; B65F 1/0006; B65F 2240/136

(57) ABSTRACT

A roll of dog waste bags that allow single bays to be pulled off the roll reliably one by one. The device may include interlocking layers, adhesives, or both to achieve this. The device includes an inner core such that it can be used on existing pet waste bag holders.

### CROSS REFERENCE TO RELATED APPLICATIONS

63/532,836

### FIELD OF THE INVENTION

The present invention relates generally to the field of dog waste collection, and more particularly to methods and systems for dog waste bag dispensing

### BACKGROUND

When walking one's pet it is common to bring a device that holds pre-rolled waste bags, such as shown in U.S. Pat. No. 7,850,039B1, in order to pick up one's pet's excrement while on a walk.

Most of these devices and waste bag rolls require the use of two hands to operate due to a perforated connection between bags. One hand holds steady the bag inside of the device, while the other tears the bag outside of the device off. A two handed operation is not ideal as one hand can be occupied and not in a position to help remove a bag, such as holding groceries, a cup of coffee, or just holding the leash one's pet is attached to.

The state of the current art is similar to that of U.S. Pat. No. 8,113,381B2, wherein small lightweight devices are added to one's existing leash that hold a roll of waste bags. There exist two current devices and bags known to this author that aim to accomplish a one handed operation, but both have flaws

The first is by Fable Pets and is called the Waste Bag Holder. This design incorporates a hook protrusion, which only when combined with their custom Waste Bags, will allow the bags to be removed with one hand. Their custom made Waste Bags have a hole that lines up with the hook on the dispenser, this hook catches the bag and allows the perforated bags to be separated easily. While an elegant solution, it requires the user to have both the Fable dispenser and the Fable bags to operate. The bags alone will not work in any other holder as a one hand solution

The second is by Diggs Inc. and is called the Easy Dispense Dog Poop Bags. This roll is unlike most other bag rolls in that all of the bags are separate and layered in the roll, but not folded together or attached by any means of adhesive. Being separate in the roll means that each new bag pulls out easily from the roll and can be operated by one hand. The downside with this product is that it does not always pull the next bag out of the holder in a reliable fashion. The user can be left fishing inside of the holder to grab the next bag, which requires more dexterity and hand work than if the user had to use two hands to separate a perforated bag. Similar to the Fable product, the dog bag operation performs most reliably when paired with the Diggs Inc. manufactured dog bag holder.

Therefore, there needs to be a more universal solution to allow one handed single bag dispensing for a broad range of dog bag holders.

### SUMMARY OF THE INVENTION

The present invention can provide a roll of bags that rotatably fits inside an outer housing. The outer housing can be a rigid structure or a flexible one.

The roll of bags can have an internal cylindrical member that can rotatably attach to the outer housing. This cylindrical member can be attached to the bags by friction of the bag wraps or it can be attached through a light adhesive. This member can be flexible or rigid and can be comprised of different materials such as cardboard, paper, or plastic.

The roll of bags can have an outer cylindrical shape to rotatably attach inside of the outer housing.

The roll of bags can be comprised of separate flexible sheets with three of four edges sealed and one edge non-sealed to create a bag shape when opened. The flexible sheets can be made of a number of materials such as thin film plastics, thin film bio-based materials, and paper. Further, the bags can be textured to increase adhesion between each bag

The bags can be overlaid for a portion incorporating roughly ¼ the full length of each bag at both ends. The full roll can then be folded lengthwise several times.

The bag roll can be held together for transport through the use of a sticker, tape, adhesive, paper wrap, clamp, or other similar design known to those in the art.

### BRIEF DESCRIPTION OF DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is an isometric view of an embodiment of the invention in which the roll is full and bags are just starting to be pulled out

FIG. 2 is an isometric view of an embodiment of existing waste bag rolls showing the first bag fully unfolding from the roll

FIG. 3 is an isometric view of an embodiment of existing waste bag rolls showing the first bag being removed from the rest of the roll

FIG. 4 is an isometric view of an embodiment of the invention showing how subsequent bags are folded into one another in the roll

### A DETAILED DESCRIPTION

Details of some embodiments of the apparatus in the present invention are described below

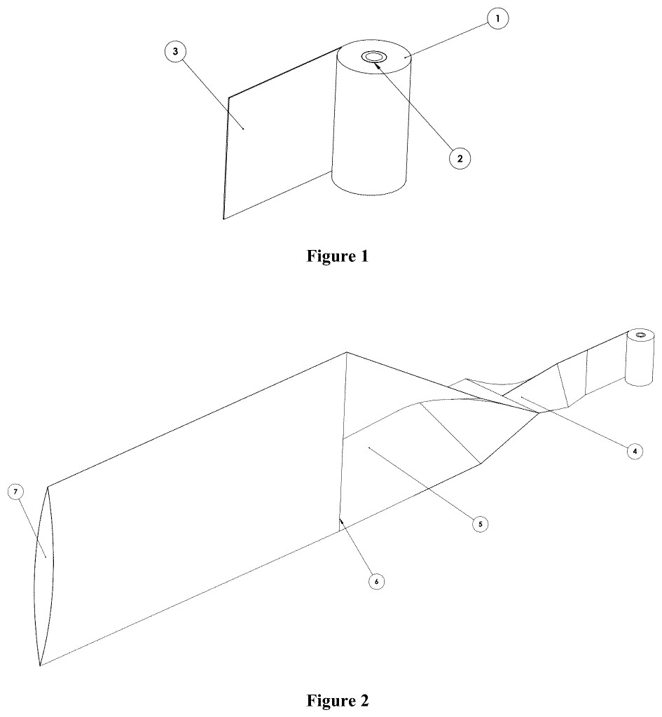

Referring to FIG. 1, in some embodiments of the design there may be an inner core 2 around which a roll of folded and flattened bags 1 is rotatably wound. The bags 1 may be attached to the core 2 by friction of a tight roll, adhesive, sticker, or similar method to those in the art. In some embodiments, the flattened bags 3 may roll off as flattened sheets. The inner core 2 can be made of a rigid material such as cardboard, paper, plastic, or it may be a wound bag itself made into a cylindrical shape. The core is shaped to fit existing pet waste bag holders.

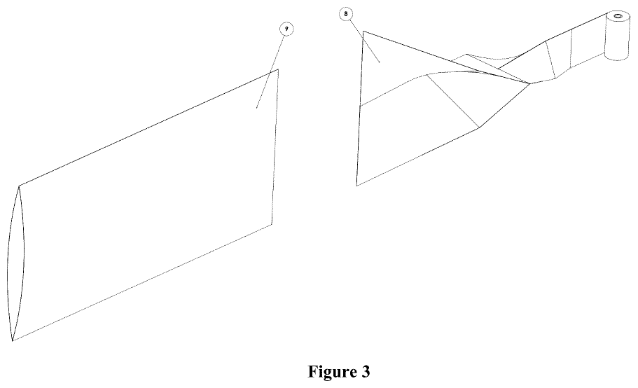

FIG. 2 and FIG. 3 show the state of the current art, in which this invention expands upon. In some rolls, the flattened bags can be folded lengthwise twice as shown in 4 and 5. It is common for bags to be separated by widthwise perforations 6. The ends of the bag 7 can be non-sealed and as such when removed from a roll the bags can have an opening at 7 and seals along the three other edges. When a bag is separated at the perforation 6, a fully contained bag 9 can be removed from the rest of the roll 8. This process can continue until the roll 8 has been spent resulting in just the inner core 2 remaining. The inner core can then be disposed of and replaced with a new full roll.

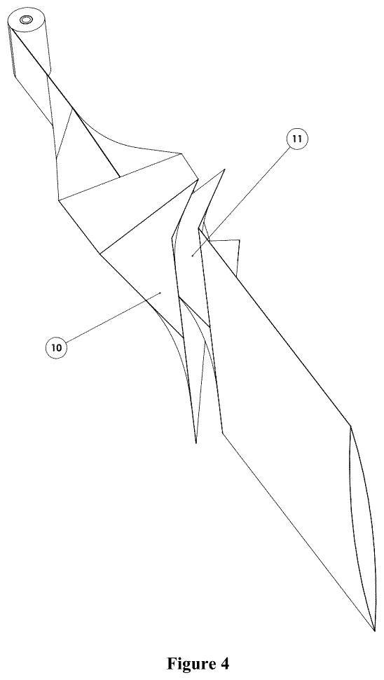

Referring to FIG. 4 an embodiment of this design can use separated bags 10 and 11 and fold them together twice or more times. In some embodiments, the bags can be further held together with a light adhesive. In some embodiments, the bags can include a texture to increase friction grip. In some embodiments, materials can be selected which promote grip between bags. The roll can then be wound and each subsequent bag folded and rolled in a similar manner.

What is claimed is:

1. A roll of pet waste bags, comprising:
Fully separated, but temporarily connected flattened bags allowing bags to be pulled off one by one.

2. The waste bags of claim 1, wherein the flattened bags are interlocked through 1 or more folds.

3. The waste bags of claim 1, wherein the flattened bags are interlocked through adhesive or tape.

4. The waste bags of claim 1, wherein the flattened bags are interlocked through friction of the waste bag surfaces.

5. The waste bags of claim 1, wherein the bags are made of flexible plastic, flexible bio-based materials, paper, silicone, or other flexible materials known to those in the art.

6. The waste bags of claim 1, wherein there is a core made of a rigid material such as cardboard, paper, plastic, or other rigid materials known to those in the art.

7. The waste bags of claim 1, wherein there is a core made of the flexible bags themselves wound into a cylinder.
